(19) United States
(12) Patent Application Publication
(10) Pub. No.: US 2011/0228351 A1
(43) Pub. Date: Sep. 22, 2011

(54) IMAGE PROCESSING APPARATUS AND IMAGE PROCESSING PROGRAM

(75) Inventors: Shigeo Uchida, Shizuoka (JP); Taira Ashikawa, Shizuoka (JP); Satoshi Oyama, Shizuoka (JP); Katsuhito Mochizuki, Shizuoka (JP)

(73) Assignee: TOSHIBA TEC KABUSHIKI KAISHA, Tokyo (JP)

(21) Appl. No.: 13/032,711

(22) Filed: Feb. 23, 2011

(30) Foreign Application Priority Data
Mar. 18, 2010 (JP) 2010-063081

(51) Int. Cl. H04N 1/04

(52) U.S. Cl. 358/474

(57) ABSTRACT

According to one embodiment, an image processing apparatus includes a scanner, a display, an accept unit, an edit unit, and a storage. The scanner is configured to scan a plurality of originals and read images thereof. The display is configured to display a preview image each time an image of one original is read by the scanner. The accept unit is configured to accept an edit process designated by an operator with respect to the preview image displayed by the display. The edit unit is configured to execute the edit process, which is accepted by the accept unit, on the image read by the scanner. The storage is configured to store the image edited by the edit unit.

### CROSS-REFERENCE TO RELATED APPLICATIONS

This application is based upon and claims the benefit of priority from Japanese Patent Application No. 2010-063081, filed on Mar. 18, 2010; the entire contents of which are incorporated herein by reference.

### FIELD

Embodiments described herein relate generally to an image processing apparatus which scans and reads an original, and an image processing program.

### BACKGROUND

In the case of an image processing apparatus which can batchwise scan and read a plurality of originals, it is possible that the read images include an image of an original whose direction is erroneous or an image of an original which is a blank sheet. In order to prevent image data with undesirable processing content from being uselessly output, most of such image processing apparatuses enable confirmation of scan data in advance.

In the prior art, as disclosed in Jpn. Pat. Appln. KOKAI Publication No. 2004-222246 (document 1), there is known an image processing apparatus which confirms scan data by preview images or thumbnail images after the scan of all pages is completed.

In addition, as disclosed in Jpn. Pat. Appln. KOKAI Publication No. 2008-193682 (document 2), there is known an image processing apparatus which can confirm scan data by generating a preview image each time one page has been scanned, prior to the completion of the scan of all originals.

In the image processing apparatus of document 1, when many originals have been scanned, a long wait time is needed before the scan data can be confirmed. On the other hand, in the image processing apparatus of document 2, there occurs no wait time as in the image processing apparatus of document 1, and preview images can be confirmed before the process of scanning all pages is completed. However, this apparatus enables merely the confirmation by preview images. Even if it is confirmed that the read images include an image of an original whose direction is erroneous or an image of an original which is a blank sheet, it is not possible to execute an edit work (e.g. rotation, deletion of a blank sheet, etc.) on the images. In the image processing apparatus of document 2, when it is confirmed from preview images that the processing content is undesirable, the output of image data which has been read by scanning is stopped (canceled), the direction of the original is corrected or the blank page is removed, and thereafter the scan process needs to be executed once again.

### BRIEF DESCRIPTION OF THE DRAWINGS

FIG. 1 is an exemplary view of a system for realizing an image processing apparatus according to an embodiment.

FIG. 2 is an exemplary block diagram illustrating the structure of an MFP in the embodiment.

FIG. 3 is an exemplary block diagram illustrating the structure of an image edit server in the embodiment.

FIG. 4 is an exemplary block diagram illustrating the structure of a client PC in the embodiment.

FIG. 5 is an exemplary block diagram illustrating the structure of an image storage device in the embodiment.

FIG. 6 is an exemplary flow chart illustrating a process of the image edit server in the embodiment.

FIG. 7 is an exemplary flow chart illustrating a process of the image edit server in the embodiment.

FIG. 8 is an exemplary flow chart illustrating a process of the client PC in the embodiment.

FIG. 9 is an exemplary flow chart illustrating a process of the MFP in the embodiment.

FIG. 10 is an exemplary flow chart illustrating a process of the image storage device in the embodiment.

FIG. 11 is an exemplary view illustrating an example of a scan setup screen which is displayed by the client PC in the embodiment.

FIG. 12 is an exemplary view illustrating an example of a preview confirmation screen which is displayed by the client PC in the embodiment.

FIG. 13 is an exemplary flow chart illustrating a part of the operation of the image edit server in the embodiment.

### DETAILED DESCRIPTION

In general, according to one embodiment, an image processing apparatus comprises a scanner, a display, an accept unit, an edit unit, and a storage. The scanner is configured to scan a plurality of originals and read images thereof. The display is configured to display a preview image each time an image of one original is read by the scanner. The accept unit is configured to accept an edit process designated by an operator with respect to the preview image displayed by the display. The edit unit is configured to execute the edit process, which is accepted by the accept unit, on the image read by the scanner. The storage is configured to store the image edited by the edit unit.

### First Embodiment

FIG. 1 is an exemplary view of a system for realizing an image processing apparatus according to a first embodiment. In this system, an MFP (Multi-Function Printer) 101, an image edit server 102 which acquires an image from the MFP 101 and edits the image, a client personal computer (PC) 103 which accepts an input from an operator, and an image storage device 104, which stores image data, execute an image processing program, thereby cooperatively realizing the image processing apparatus. In addition, the present system includes a network 105 which interconnects the MFP 101, image edit server 102, client PC 103 and image storage device 104, thus enabling mutual transmission/reception of data. The network 105 is, for instance, the Internet or a LAN (Local Area Network).

In the image processing apparatus of the first embodiment, preview confirmation screens are successively created by the image edit server 102, with respect to images of a plurality of originals which are read by the MFP 101. The preview confirmation screens are displayed on the client PC 103. According to an instruction from the operator, an edit, such as rotation of an image whose direction is erroneous or deletion of a read image of a blank original, is executed. Thus, image data that is a read result can be generated. Thereby, when a plurality of originals are scanned and read, the image data can successively be edited while the preview images are confirmed, before the scan of all pages is completed.

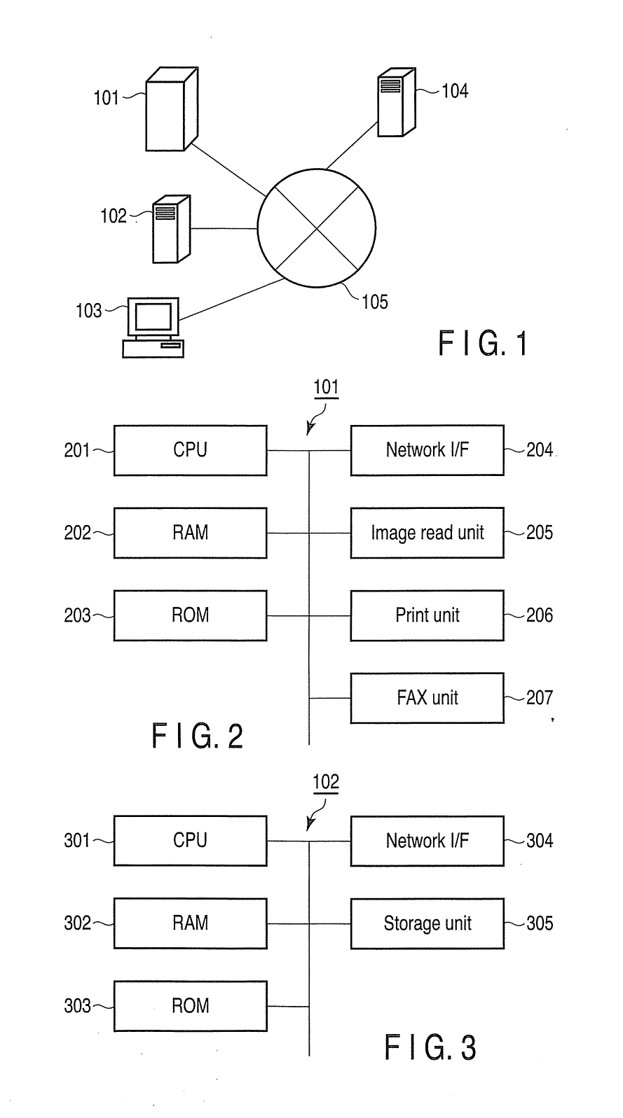

As shown in FIG. 2, the MFP 101 includes a CPU (Central Processing Unit) 201 which executes processes such as data control and arithmetic calculation, a RAM (Random Access Memory) 202 which temporarily stores data which is to be processed by the CPU 201, a ROM (Read Only Memory) 203 which stores a processing program, etc., and a network interface (I/F) 204 for input/output of data via the network 105. In addition, the MFP 101 is provided with an image read unit 205, a print unit 206 and a FAX unit 207, and provides a scanner function, a printer function and a FAX function under the control of the CPU 201. The MFP 101 can read image data by batch-scanning a plurality of originals by the scanner function. The read image data is output to the image edit server 102 as a target of edit.

As shown in FIG. 3, the image edit server 102 includes a CPU 301 which executes processes such as data control and arithmetic calculation, a RAM 302 which temporarily stores data which is to be processed by the CPU 301, a ROM 303 which stores a processing program, etc., a network interface (I/F) 304 for input/output of data via the network 105, and a storage unit 305 for storing a processing program, files of image data, etc. The CPU 301 executes the image processing program which is stored in the ROM 303, thereby executing various edit processes on image data which is input from the MFP 101 via the network 105. The edit processes by the image edit server 102 include generation of preview images, image edit (rotation, deletion, etc.) which is instructed by the operator who is notified from the client PC 103, and conversion of file formats (single, multi).

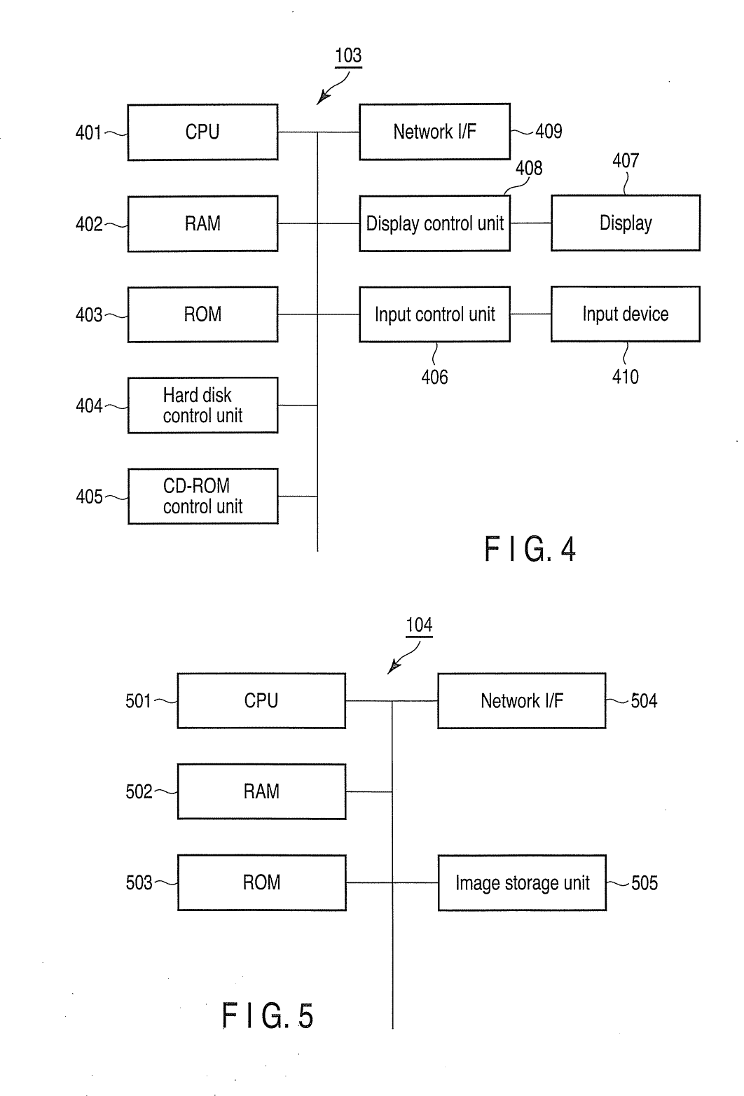

As shown in FIG. 4, the client PC 103 includes a CPU 401 which executes processes such as data control and arithmetic calculation, a RAM 402 which temporarily stores data which is to be processed by the CPU 401, a ROM 303 which stores a processing program, etc., a hard disk control unit 404 which controls data read/write on a hard disk (HD) for storing data for a long time, and a CD-ROM control unit 405 which controls read from a CD-ROM which stores programs, etc. In addition, the client PC 103 includes an input control unit 406 which controls an input device 410 such as a keyboard or a mouse; a display control unit 408 which controls a display 407 that displays information (including a preview confirmation screen) from the image edit server 102; and a network interface (I/F) 409 for input/output of data via the network 105.

As shown in FIG. 5, the image storage device 104 includes a CPU 501 which executes processes such as data control and arithmetic calculation, a RAM 502 which temporarily stores data which is to be processed by the CPU 501, a ROM 503 which stores a processing program, etc., a network interface (I/F) 504 for input/output of data via the network 105, and an image storage unit 505 which is composed of, e.g. a hard disk drive for storing image data.

In the case where the MFP 101, image edit server 102, client PC 103 and image storage device 104 cooperatively realize the image processing apparatus, an image processing program for the process (to be described later in detail), which is to be executed in each component, is recorded in the recording medium and executed by the CPU.

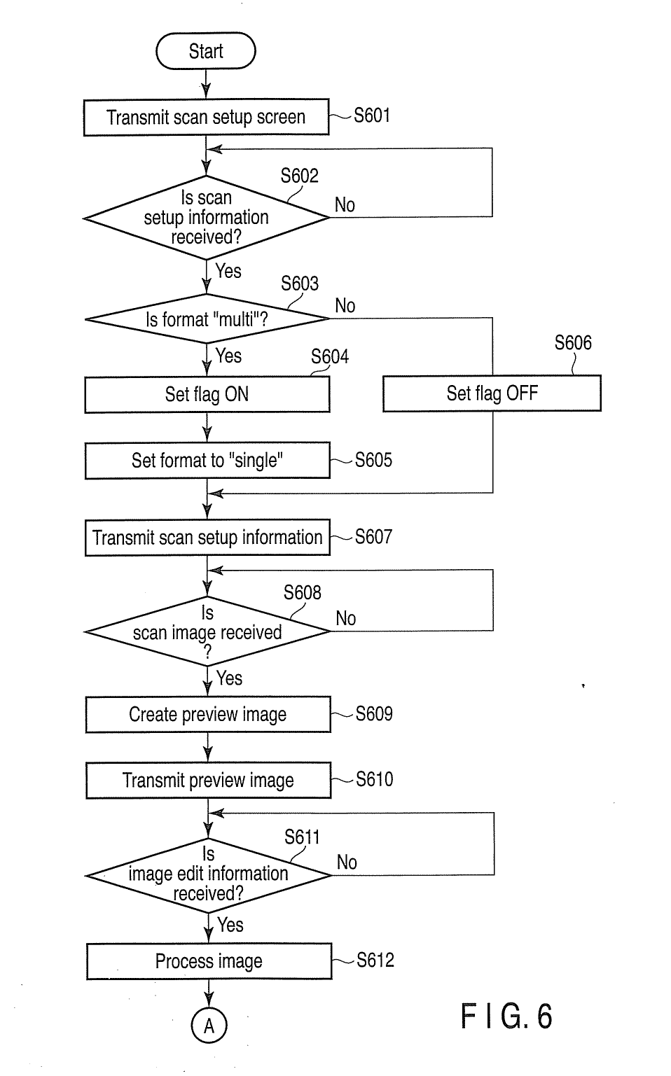

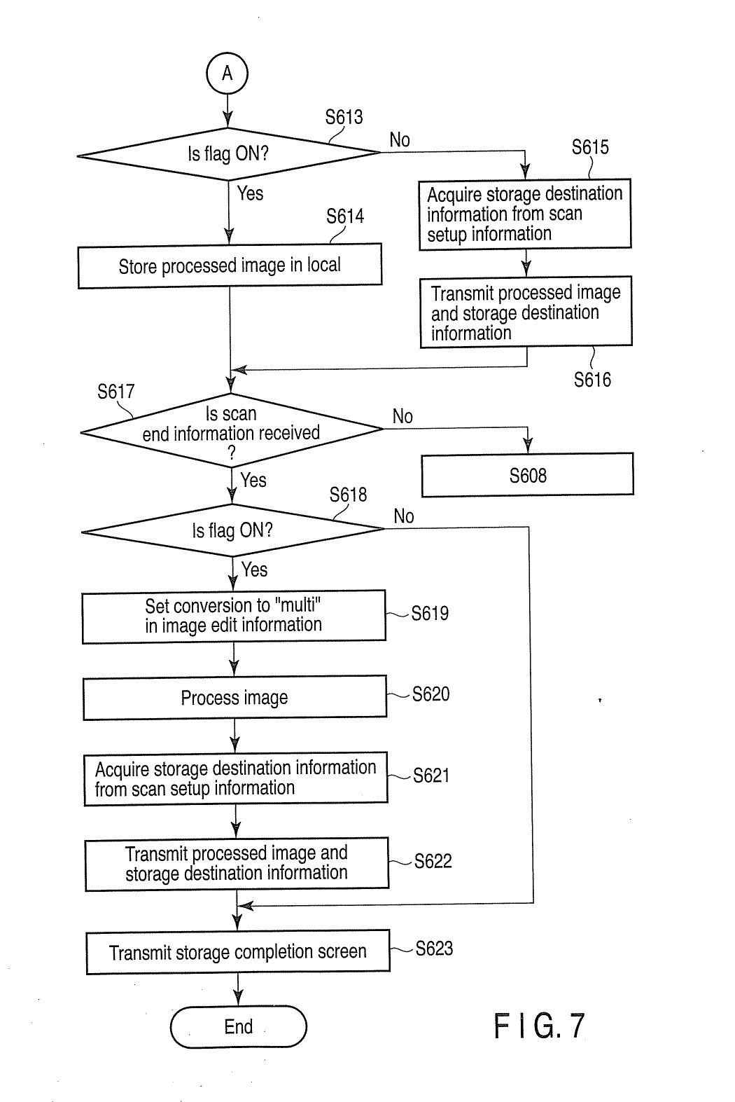

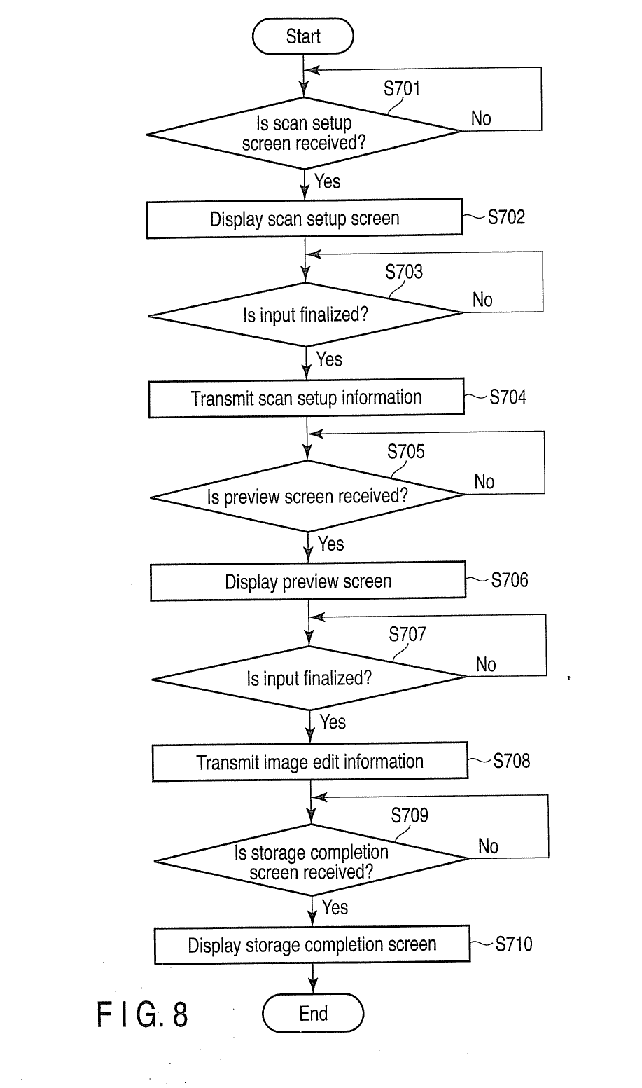

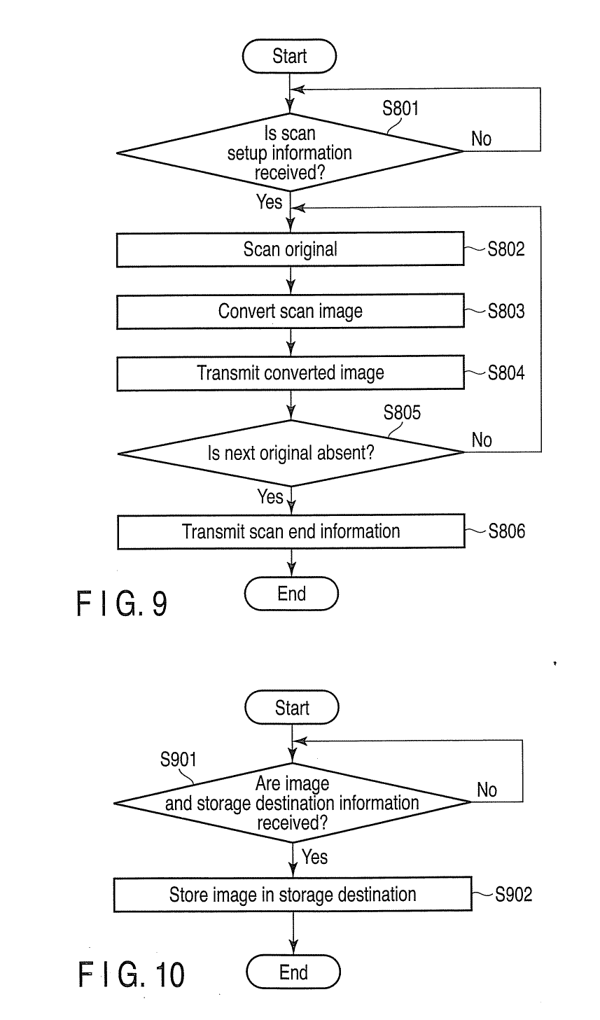

Next, referring to flow charts of FIG. 6 to FIG. 10, a description is given of the process procedure for storing images, which are obtained by scanning originals by the MFP 101, into the image storage device 104 through edit operations by the operator. FIG. 6 and FIG. 7 are flow charts illustrating the process of the image edit server 102. FIG. 8 is a flow chart illustrating the process of the client PC 103. FIG. 9 is a flow chart illustrating the process of the MFP 101. FIG. 10 is a flow chart illustrating the process of the image storage device 104.

To start with, if the image edit server 102 is connected to the MFP 101 and client PC 103 via the network 105, the image edit server 102 transmits scan setup screen information for executing scan setup to the client PC 103 (FIG. 6, Act S601).

If the client PC 103 is connected to the image edit server 102, the client PC 103 transitions to a state of wait for the reception of the scan setup screen information from the image edit server 102. If the client PC 103 detects the reception of the scan setup screen information (FIG. 8, Yes in Act S701), the client PC 103 displays a scan setup screen on the display 407, based on the scan setup screen information (Act S702).

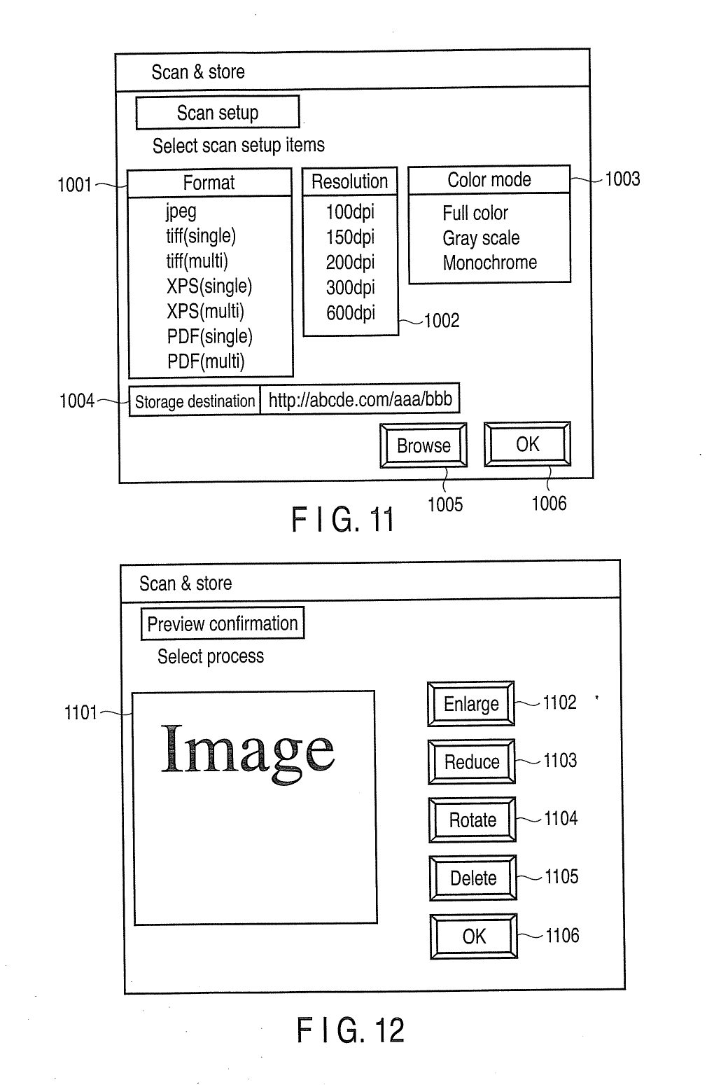

FIG. 11 is an exemplary view illustrating an example of the scan setup screen which is displayed by the display 407 of the client PC 103.

In the scan setup screen shown in FIG. 11, an upper left part of the screen indicates that the application, which is being executed, is “Scan & Store” for storing a file of an image which has been read by scanning an original by the MFP 101. In the scan setup screen, “Scan setup” is displayed in order to indicate that the screen is a setup screen for executing various settings relating to scan.

In addition, in the scan setup screen, a plurality of setup areas are provided in order to prompt the operator to select scan setup items. For example, there are provided a file format area 1001 for selecting a file format when a scanned image is to be stored as a file, a resolution area 1002 for selecting the resolution for scanning the original, and a color mode area 1003 for selecting a color mode.

As shown in FIG. 11, a list of file formats is displayed in the file format area 1001. The file formats include a single file format for handling image data, which is read by scanning a single original, as a single file, and a multi-file format for integrating image data, which is read by scanning a plurality of originals, into a single file. File formats, which are indicated by Tiff, XPS, and PDF, correspond to multi-file formats.

The scan setup screen is provided with a storage destination area 1004 for prompting the operator to input a storage destination (PC name or folder name) to which an image file obtained by scan is to be stored.

In addition, the scan setup screen is provided with a browse button 1005 for enhancing the operability with respect to the input of the storage destination. If the browse button 1005 is pressed by the operator, a storage destination select screen is displayed, so that the operator may select the location of storage of a file by a GUI (Graphical User Interface).

Besides, the scan setup screen is provided with an OK button 1006 for finishing the selection of the scan setup items and the input of the storage destination, and causing the client PC 103 to execute the process.

The client PC 103 determines whether the OK button 1006 shown in FIG. 11 has been pressed by the operator (“finalization of input”) (FIG. 8, Act S703). If the client PC 103 detects that the OK button 1006 has been pressed by the operator (Yes in Act S703), the client PC 103 transmits the scan setup information to the image edit server 102 from the network interface 409 via the network 105 (Act S704).

If the image edit server 102 receives the scan setup information from the client PC 103 via the network interface 304 (FIG. 6, Yes in Act S602), the image edit server 102 determines whether the scan file format included in the received scan setup information is a multi-file format corresponding to plural pages, such as PDF, Tiff or XPS (Act S603). If the scan file format is the multi-file format corresponding to plural pages (Yes in Act S603), the image edit server 102 sets ON an image integration flag for determining whether image data is to be integrated after an image edit (processing) which will be described later (Act S604), and changes the multi-file format, which is the scan file format included in the scan setup information, to a single file format (Act S605). Specifically, an edit process for image data of a single original is enabled.

On the other hand, if the scan file format is the single file format (No in Act S603), the image integration flag is set OFF (act S606). Specifically, if the scan file format is the single file format, the file format is not changed since it is possible to execute the edit process for image data of a single original.

The image edit server 102 transmits the scan setup information, which is obtained from the client PC 103, to the MFP 101 from the network interface 304 via the network 105 (Act S607).

If the MFP 101 receives the scan setup information from the image edit server 102 via the network interface 204 (FIG. 9, Yes in Act S801), a single original is scanned, based on the received scan setup information (resolution, color mode, etc.) (Act S802). Then, the file format of the scan image is converted according to the scan file format included in the scan setup information (Act S803). It should be noted, however, that the scan file format is set to be the single file format without fail, by the process of Act S603 to Act S606 of the image edit server 102.

The MFP 101 transmits the data of the format-converted scan image to the image edit server 102 from the network interface 204 via the network 105 (Act S804).

If the image edit server 102 receives the scan image from the MFP 101 via the network interface 304 (FIG. 6, Yes in Act S608), the image edit server 102 creates a preview image for preview-displaying the received image (Act S609). Then, the image edit server 102 transmits the display data of the preview confirmation screen including the preview image to the client PC 103 from the network interface 304 via the network 105 (Act S610).

If the client PC 103 receives the display data of the preview confirmation screen from the image edit server 102 (FIG. 8, Yes in Act S705), the client PC 103 displays the preview confirmation screen on the display 407 (Act S706).

FIG. 12 illustrates an example of the preview confirmation screen which is displayed by the display 407 of the client PC 103.

In the preview confirmation screen shown in FIG. 12, an upper left part of the screen indicates that the application, which is being executed, is “Scan & store”. In addition, this screen displays “Preview confirmation” in order to indicate that the screen is the preview confirmation screen. The preview confirmation screen is provided with an image display are 1101 which displays the preview image; an enlargement button 1102, a reduction button 1103, a rotation button 1104 and a delete button 1105 for accepting from the operator an edit operation on the preview image displayed in the image display area 1101; and an OK button for accepting an instruction to finish the image edit work (“finalization of input”).

When the enlargement button 1102 is pressed by the operator, the image display area 1101 displays an image which is formed by subjecting the original displayed preview image to an enlargement process. When the reduction button 1103 is pressed by the operator, the image display area 1101 displays an image which is formed by subjecting the original displayed preview image to a reduction process. The process of enlarging/reducing the image by operating the enlargement button 1102 and reduction button 1103 is a process for enabling the operator to confirm the image, and the original image is not edited (i.e. the enlargement/reduction is not included in the image edit information for informing the image edit server 102 of the edit content).

On the other hand, when the rotation button 1104 is pressed by the operator, the image display area 1101 displays an image which is formed by rotating the original displayed preview image by 90° to the left. In addition, when the delete button 1105 is pressed by the operator, the preview image in the image display area 1101 is set in the non-displayed state.

In this example, when the rotation button 1104 is pressed by the operator, the image is rotated by 90° to the left. However, the rotation process is not limited to this example, and the image may be rotated by 90° to the right, or may be rotated by 180°.

The client PC 103 generates the image edit information indicative of the edit content which is input through the preview confirmation screen and instructed by the operator. For example, the image edit information comprises information indicating the number of times of pressing of the rotation button 1104, or information indicating that the delete button 1105 has been pressed.

If the client PC 103 detects that the image edit work by the operator has been finished and the OK button 1106 has been pressed (“finalization of input”) (Yes in Act S707), the client PC 103 transmits the image edit information to the image edit server 102 from the network interface 409 via the network 105 (Act S708).

If the image edit server 102 receives the image edit information from the client PC 103 via the network interface 304 (FIG. 6, Yes in Act S611), the image edit server 102 processes (edits) the image according to the image edit information (Act S612). If the image edit information includes information indicating the number of times of pressing of the rotation button 1104, the image is rotated by an angle corresponding to this number of times. For example, if the number of times of pressing is one, the image is rotated by 90° to the left. If the number of times of pressing is two, the image is rotated by 180° to the left. Besides, when the image edit information includes information indicating that the delete button 1105 has been pressed, an image edit is executed to delete the image that is the target of edit.

If the image edit of the rotation or deletion according to the instruction from the operator is completed, the image edit server 102 checks the value of the image integration flag. If the image integration flag is ON (Yes in Act S613), the image edit server 102 needs to integrate images into a single file in a multi-file format. Thus, the image edit server 102 temporarily stores the images, which have been processed in Act S612, in a local (the RAM 302 in the image edit server 102 or the storage unit 305) (Act S614). In this case, the images are stored under file names to which the present date and time are added. If it is possible to manage files in the order of the scan process, the files may be stored in some other form, for example, with serial numbers being added. Besides, if the image edit information is “delete”, the temporal storage of the file is not performed.

On the other hand, if the image integration flag is OFF (No in Act S613), the image edit server 102 does not need to integrate images into a single file. Thus, the image edit server 102 acquires storage destination information from the scan setup information which has been acquired in Act S602 (Act S615). In the storage destination information, the PC name or folder name is described as the information relating to the image storage device 104 which stores the file. The image edit server 102 transmits the image that is to be stored and the storage destination information to the image storage device 104, which is indicated by the storage destination information, via the network interface 304 (Act S616).

If the image storage device 104 receives the image that is to be stored and the storage destination information from the image edit server 102 via the interface 504 (Yes in Act S901), the image storage device 104 stores the received image in the storage destination folder which is designated by the storage destination information (FIG. 10, Act S902).

On the other hand, the MFP 101 determines whether there is an original which is to be next scanned, that is, whether an original that is a target of scan is set (FIG. 9, Act S805). If the MFP 101 determines that there is an original which is to be next scanned (No in Act S805), the MFP 101 scans the next original in the same manner as described above (Act S802). In this case, the MFP 101 converts the format of the scanned and read image, and transmits the image data to the image edit server 102.

If the image edit server 102 does not receive scan end information from the MFP 101 (FIG. 7, No in Act S617) and receives a scan image from the MFP 101 (Yes in Act S608), the image edit server 102 generates a preview image, as described above. Subsequently, in the same manner, the preview confirmation screen is displayed on the client PC 103, and the edit operation of rotation or deletion, which is input from the operator, is accepted to execute the image edit.

If the MFP 101 completes the scan of all set originals and determines that there is no original which is to be next scanned (Yes in Act S805), the MFP 101 transmits scan end information to the image edit server 102 from the network interface 204 via the network 105 (Act S806).

If the image edit server 102 receives the scan end information from the MFP 101 (Yes in Act S617), the image edit server 102 determines whether the image integration flag is set ON or OFF. If the image edit server 102 determines that the image integration flag is OFF (No in Act S618), the file format is the single file format and the file integration process is needless. Thus, the image edit server 102 transmits a storage completion screen for notifying the end of the process to the client PC 103 from the network interface 304 via the network 105 (Act S623).

On the other hand, if the image edit server 102 determines that the image integration flag is ON (Yes in Act S618), the file format which is designated by the operator is the multi-file format, and plural image files need to be integrated into a single file. Thus, the image edit server 102 sets in the image edit information the file integration process for file integration to the multi-file format (Act S619).

According to the set image edit information, the image edit server 102 integrates all image files, which are temporarily stored in the local, into a single file (Act S620). In this case, in order to make uniform the order of the image files corresponding to the originals so that the order of all image files stored in the local may become the same as the order of scan of the originals in the MFP 101, the image edit server 102 rearranges the image files in an ascending order according to the dates and times added to the files of all image files temporarily stored in the local, and then integrates the image files into a single file. Thereby, even if there is an image file which was temporarily stored as a single-format file in the image edit server 102 and was deleted by the operator's instruction, it becomes possible to generate a file of a multi-file format, which comprises a plurality of images arranged in the order of originals read by the scan process.

Subsequently, the image edit server 102 acquires storage destination information from the scan setup information which has been acquired from the client PC 103 in Act S602 (Act S621), and transmits the image file that is to be stored and the storage destination information to the image storage device 104 via the network interface 304 (Act S622). In addition, the image edit server 102 transmits a storage completion screen for notifying the end of the process to the client PC 103 from the network interface 304 via the network 105 (Act S623).

If the client PC 103 detects that the storage completion screen information has been received from the image edit server 102 (Yes in Act S709), the client PC 103 displays the storage completion screen on the display 407 (Act S710). Thereby, the operator can confirm that the image files of the originals, which have been scanned and read by the MFP 101, are stored in the image storage device 104.

In this manner, in the system (image processing apparatus) of the first embodiment, each time an original is scanned by the MFP 101, a preview image is generated in the image edit server 102. The operator is made to confirm the preview image on the client PC 103, an edit instruction for rotation or deletion is accepted, and the edit process can be executed. Therefore, even in the case where a large number of originals are scanned, the operator can successively confirm an original whose direction is erroneous or an original of a blank sheet, without waiting for the completion of scan of all originals, and can perform an edit work on images.

### Second Embodiment

Next, a second embodiment is described. In a system (image processing apparatus) of the second embodiment, the operability for the operator is improved in the case where the number of originals to be scanned is large. A description of the parts common to the first embodiment is omitted, and only characteristic parts of the second embodiment are described.

To begin with, it is assumed that an auto-original-feed time is preset as scan setup information of the application of “Scan & store” which stores files of images read by scanning originals by the MFP 101. The auto-original-feed time is set by an instruction which is input from the operator through the scan setup screen on the client PC 103, as in the case of the first embodiment. The auto-original-feed time is indicative of a time for automatically displaying the next preview confirmation screen, even without an operation on the OK button 1006 with respect to a preview image displayed on the client PC 103.

Instead of the process of Act S707 in the flow chart of FIG. 8, the client PC 103 determines whether the OK button 1106 has been pressed by the operator, and whether the time that is set as the auto-original-feed time has passed since the preview image was displayed in the image display area 1101 of the preview confirmation screen.

When the client PC 103 detects that the OK button 1106 was pressed before the time that is set as the auto-original-feed time has passed, the client PC 103 executes, the process of Act S708 (transmission of image edit information).

When the client PC 103 detects that the time that is set as the auto-original-feed time has passed since the preview image was displayed, without the OK button 1106 being pressed by the operator, the client PC 103 executes the process of Act S708 even if the OK button 1106 is not pressed by the operator.

In this manner, in the second embodiment, when the edit process on the preview image is needless, the operator can automatically confirm the next preview confirmation screen by merely waiting for the passing of the auto-original-feed time, without the need to press the OK button 1106 shown in FIG. 12. In other words, the number of times of operation on the preview confirmation screen can be decreased, and the work load on the operator can be reduced.

### Third Embodiment

Next, a third embodiment is described. In the third embodiment, it is possible to adapt to the case where the time for confirming the preview image of the scanned image is longer than the time of scan of the original. A description of the parts common to the first embodiment is omitted, and only characteristic parts of the third embodiment are described.

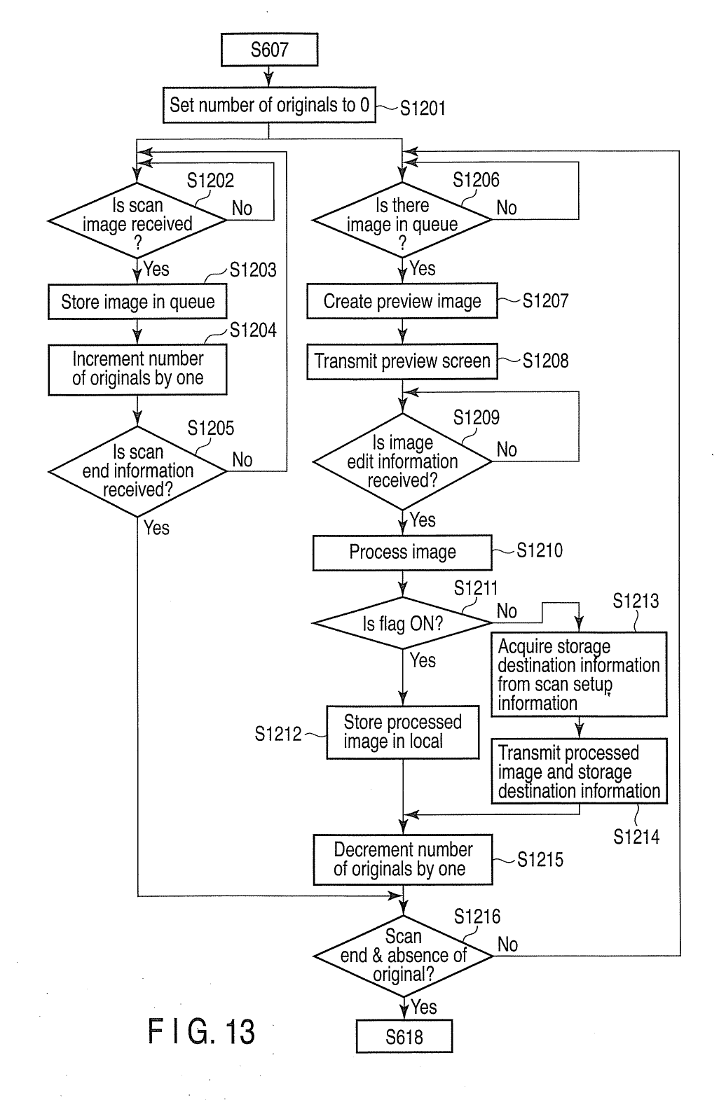

FIG. 13 is an exemplary flow chart illustrating a part of the operation of the image edit server 102 in the third embodiment.

In the third embodiment, in the image edit server 102, a queue (RAM 302 or storage unit 305) is provided as a buffer for temporarily storing image data which is read by the MFP 101.

In the third embodiment, the process of Act S608 to Act S617 of the image edit server 102, which is illustrated in the flow charts of FIG. 6 and FIG. 7, is altered as illustrated in FIG. 13. Following Act S607 in FIG. 6, the image edit server 102 sets the number of originals to 0 (FIG. 13, Act S1201).

Subsequently, the image edit server 102 determines whether the scan image has been received from the network interface 304 (Act S1202). In parallel with this, the image edit server 102 determines whether image files are present in the queue (Act S1206). If the image edit server 102 determines that the scan image has been received (Yes in Act S1202), the image edit server 102 stores the received scan image in the queue in order (Act S1203) and increments the number of originals by one (Act S1204).

Subsequently, the image edit server 102 determines whether the scan end information has been received from the MFP 101 via the network interface 304 (Act S1205). If the image edit server 102 determines that the scan end information has not been received (No in Act S1205), the next original is present and thus the image edit server 102 returns to Act S1202. Then, the image edit server 102 determines whether the scan image has been received. On the other hand, if the image edit server 102 determines that the scan end information has been received (Yes in Act S1205) and that the number of originals is 0 (Yes in Act S1216), there is no more image file and thus the image edit server 102 advances to the next process (Act S618).

On the other hand, if the image edit server 102 determines whether image files are present in the queue (Yes in Act S1206), the image edit server 102 acquires one image file from the queue in the order of storage of image files, and creates a preview image which is to be displayed for preview (Act S1207). Then, the image edit server 102 transmits the preview confirmation screen including the preview image to the client PC 103 from the network interface 304 via the network 105 (Act S1208).

If the image edit server 102 receives the image edit information from the client PC 103 via the network interface 304 (Yes in Act 1209), the image edit server 102 processes (edits) the image according to the image edit information (Act S1210). If the image edit information includes information indicating the number of times of pressing of the rotation button 1104, the image is rotated by an angle corresponding to this number of times. For example, if the number of times of pressing is one, the image is rotated by 90° to the left. If the number of times of pressing is two, the image is rotated by 180° to the left. Besides, when the image edit information includes information indicating that the delete button 1105 has been pressed, an image edit is executed to delete the image that is the target of edit.

If the image edit of the rotation or deletion according to the instruction from the operator is completed, the image edit server 102 checks the value of the image integration flag. If the image integration flag is ON (Yes in Act S1211), the image edit server 102 needs to integrate images into a single file in a multi-file format. Thus, the image edit server 102 temporarily stores the images, which have been processed in Act S1210, in the local (the RAM 302 in the image edit server 102 or the storage unit 305) (Act S1212). In this case, the images are stored under file names to which the present date and time are added. If it is possible to manage files in the order of the scan process, the files may be stored in some other form, for example, with serial numbers being added. Besides, if the image edit information is “delete”, the temporal storage of the file is not performed.

On the other hand, if the image integration flag is OFF (No in Act S1211), the image edit server 102 does not, need to integrate images into a single file. Thus, the image edit server 102 acquires storage destination information from the scan setup information which has been acquired in Act S1210 (Act S1213). In the storage destination information, the PC name or folder name is described as the information relating to the image storage device 104 which stores the file. The image edit server 102 transmits the image that is to be stored and the storage destination information to the image storage device 104, which is indicated by the storage destination information, via the network interface 304 (Act S1214).

Subsequently, the image edit server 102 decrements the number of originals by one (Act S1215), and determines whether the scan end information has been received from the MFP 101 via the network interface 304 and whether the number of originals is 0 or not (Act S1216). If the image edit server 102 determines that the scan end information has not been received or that the number of originals is not 0 (No in Act S1216), the image edit server 102 returns to Act S1206 since there is the next original, and determines whether there is an image file in the queue (Act 1206). On the other hand, if the image edit server 102 determines that the scan end information has been received and that the number of originals is 0 (Yes in Act S1216), the image edit server 102 advances to the next process since there is no more image file (Act S618). The subsequent process is the same as Act S618 in FIG. 7.

In this manner, in the third embodiment, the queue serves as the buffer. Thus, even if time is needed by the confirmation of the preview image and the edit operation by the operator, the scan process of originals by the MFP 101 can be executed in parallel with the image edit in the order of storage of images in the queue. Since the edit process and the scan process can be executed in parallel, the whole processing time can be reduced. In the meantime, the third embodiment may be implemented in combination with the second embodiment.

In the above description of each of the embodiments, the image edit of rotation or deletion of images read by the MFP 101 has been described by way of example. However, other image edits can be executed. For example, enlargement/reduction, a deformation process such as cutting, or color correction may be executed.

In each embodiment, the image processing apparatus is realized by the system comprising the MFP 101, image edit server 102, client PC 103 and image storage device 104. However, the image processing apparatus may be realized by other structures. For example, the MFP 101 can be configured as the image processing apparatus, by causing the MFP 101 to execute an image processing program which realizes the functions of the image edit server 102, client PC 103 and image storage device 104. In this case, the MFP 101 can read images, edit images and store edited images. Besides, the image processing apparatus can be realized by arbitrarily combining some of the MFP 101, image edit server 102, client PC 103 and image storage device 104. In this case, an image processing program corresponding to the process, which is to be executed by the combined apparatus, is stored, and the image processing program is executed by the CPU. For example, the image edit server 102 may execute the process of the image storage device 104, without distinction between the image edit server 102 and image storage device 104.

Furthermore, the image processing program may be pre-recorded in each device, or may be downloaded from, e.g. a server via the network 105. The image processing program may be installed in each device from a recording medium in which the image processing program is recorded. As the recording medium, for example, CD-ROM may be used to store the program. The type of the recording medium is not limited, if the recording medium can be read by each device. The function, which is obtained by preinstall or download, may be realized in cooperation with, e.g. the OS in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a scanner configured to scan a plurality of originals and read images thereof;
a display configured to display a preview image each time an image of one original is read by the scanner;
an accept unit configured to accept an edit process designated by an operator with respect to the preview image displayed by the display;
an edit unit configured to execute the edit process, which is accepted by the accept unit, on the image read by the scanner; and
a storage configured to store the image edited by the edit unit.

2. The image processing apparatus of claim 1, further comprising an output format accept unit configured to accept a format in which images read by scanning the plurality of originals are integrated into a single file,
wherein the edit unit is configured to edit the images read by scanning the plurality of originals by the edit process, and to then integrate the edited images into the single file of the format.

3. The image processing apparatus of claim 1, further comprising a storage unit configured to temporarily store the images in order, which are read by the scanner,
wherein the display is configured to display preview images of the images in an order of storage in the storage unit.

4. The image processing apparatus of claim 1, further comprising a setup unit configured to set, according to a user operation, a time until a preview image of a next image is displayed by the display,
wherein the display is configured to display the preview image of the next image in accordance with the time.

5. The image processing apparatus of claim 3, further comprising a setup unit configured to set, according to a user operation, a time until a preview image of a next image is displayed by the display,
wherein the display is configured to display the preview image of the next image in accordance with the time.

6. An image processing method comprising:
scanning a plurality of originals and reading images thereof;
displaying a preview image each time an image of the original is read;
accepting an edit process designated by an operator with respect to the preview image;
executing the accepted edit process on the image read by the scanning; and
storing the edited image.

7. The image processing method of claim 6, further comprising accepting designation of a format, in which images read by scanning the plurality of originals are integrated into a single file, as an image output format,
wherein the editing includes editing the images read by scanning the plurality of originals by the edit process, and then integrating the edited images into the single file of the format.

8. The image processing method of claim 6, further comprising temporarily storing the images in order, which are read by the scanning,
wherein the displaying includes displaying preview images of the images in an order of the storing.

9. The image processing method of claim 6, further comprising setting a time until a preview image of a next image is displayed,
wherein the displaying includes displaying the preview image of the next image in accordance with the time.

10. The image processing method of claim 8, further comprising setting a time until a preview image of a next image is displayed,
wherein the displaying includes displaying the preview image of the next image in accordance with the time.

11. A non-transitory computer readable medium having stored thereon a computer program which is executable by a computer, the computer program controlling the computer to execute functions of:
scanning a plurality of originals and reading images thereof;
displaying a preview image each time an image of the original is read;
accepting an edit process designated by an operator with respect to the preview image;
executing the accepted edit process on the image read by the scanning; and
storing the edited image.
